(19) United States
(12) Patent Application Publication
(10) Pub. No.: US 2014/0290704 A1
(43) Pub. Date: Oct. 2, 2014

(54) Method and Device for Cleaning a Surface of a Steel Product

(71) Applicant: ThyssenKrupp Steel Europe AG, Duisburg (DE)

(72) Inventor: Eberhard Sowka, Dinslaken (DE)

(21) Appl. No.: 14/360,422

(22) PCT Filed: Nov. 22, 2012
(86) PCT No.: PCT/EP2012/073332

§ 371 Date: May 23, 2014

(30) Foreign Application Priority Data
Nov. 25, 2011 (DE) 10 2011 119 334.4

(51) Int. Cl. B08B 3/04

(52) U.S. Cl. CPC B08B 3/04
USPC 134/34; 134/198

(57) ABSTRACT

A method and a device for cleaning a surface of a steel product, wherein a fluid jet is directed from a nozzle, which is located in a position associated with an edge of the surface to be cleaned, onto the surface, wherein, during the cleaning operation, there is produced a relative movement between the nozzle and the steel product and the fluid jet is orientated transversely relative to the direction of the relative movement of the steel product and nozzle. Another nozzle is located in a position which is associated with the edge of the surface, which edge is opposite the edge of the steel product associated with the first nozzle, wherein another fluid jet is directed onto the surface without any overlap, wherein the striking region of the fluid jets is spaced apart from the edge which is associated with the nozzle which produces the fluid jet.

The invention relates to a method for cleaning a surface of a steel product, in which a fluid jet is directed from a nozzle, which is located in a position which is associated with an edge of the surface to be cleaned, onto the surface to be cleaned. In this instance, during the cleaning operation, there is produced a relative movement between the nozzle and the steel product and the fluid jet is orientated transversely relative to the direction of the relative movement of the steel product and nozzle.

The invention also relates to a device which is suitable for carrying out such a method and which has a nozzle which is associated with an edge of the surface of the steel product to be cleaned for applying a first fluid jet.

The term “steel products” is intended in particular to be understood in this instance to include slabs, thin slabs or flat steel products, as in hot strip or hot metal sheet which is hot-rolled from thin slabs or slabs, which each have at least one planar surface which extends over the width of the respective steel product.

Methods and devices of the type according to the invention are intended in particular for use in a so-called “casting and rolling installation”. In such installations, in a continuously running production process, steel melt is cast to form a billet, from which thin slabs having a thickness which is typically up to 100 mm are then separated and are subsequently hot-rolled in a hot-rolling segment which is located in line with respect to the casting installation to form a hot strip. Between the production thereof and the hot-rolling, the thin slabs if necessary pass through another furnace in which they are brought to the optimum temperature in each case for the hot-rolling.

During the production of steel products, it is necessary at various times of the production process to free at least one of the surfaces of the intermediate product which is present at these times from contamination or reaction products which are bonded thereto and which occur as a result of the reaction of the steel components present on the surface of the steel product with the surrounding atmosphere. In order to ensure optimum surface quality of the hot strip, for example, during the production of a hot strip in a casting and rolling installation of the above-mentioned type, the scale which is bonded to the thin slab to be hot-rolled in each case is removed to the greatest possible extent before the thin slab is introduced into the first rolling stand of the hot-rolling segment.

If particles of scale on the surface of a flat steel product are present on the slab to be hot-rolled in each case when entering a rolling stand, these are also carried into the rolling gap and lead to defect locations in the form of so-called “scale indentations” on the surface of the hot strip obtained. These scale indentations are highly problematic since they are difficult to pickle out, bring about increased roughness on the strip surface and in the case in which the hot strip is intended to be covered with a metal layer which protects from corrosion, can bring about coating defects.

In the case of a heaped occurrence of scale accumulations on the steel product to be rolled in each case, the problem may be further anticipated that the operating rollers of the roller stands which come into contact with the scale-covered surface become damaged. Peeling of roller material can thus occur or scale can accumulate on the roller surface. Both occurrences can bring about so-called “scale scarring” on the rolled strip and lead to increased wear of the rollers of the roller stand involved.

Contamination and reaction products which are present on the steel strip can be removed in practice by means of high-pressure blasting of the relevant surface in each case. In this instance, a fluid jet which is produced at high pressure is directed onto the surface to be cleaned. The contamination and accumulations of oxide which are bonded to the surface are intended to be separated from the surface by means of the fluid jet which strikes it with high kinetic energy and be washed away from the steel product by the discharged fluid. In this instance, water is typically used as a jet fluid.

Blasting devices which are used in practice on casting roller installations for cleaning thin slabs before the hot-rolling operation generally comprise at least one nozzle device which is arranged at the operating side upstream of the first roller stand of the roller segment and which acts with a water jet at a fixedly adjusted flat angle on the surface of the slabs which are guided on the rollers. It has been found to be problematic that, with such blasting devices, it is possible to react only poorly when steel products of different widths are intended to be processed successively. With the known blasting devices, it must thus always be ensured that the fluid jet sweeps over the entire width of the surface to be cleaned in a uniform manner. Furthermore, it has been found that, with a surface cleaning operation which is carried out in such a manner with a fluid jet, there is the risk of formation of cracks in the region of the edges of the steel product, which edges the fluid jet strikes.

Against this background, an object of the invention was to provide a method and a device for removing contamination and oxidation products which adhere to the surface of a steel product and which can be adapted in a simple manner to modified dimensions of the steel product to be cleaned in each case and with which at the same time the risk of the occurrences of cracks at the edges of the steel product to be cleaned is minimised.

With regard to the method, this object is achieved according to the invention in that such a method comprises the operating steps set out in claim 1.

With respect to the device, the object mentioned above is achieved according to the invention in that such a device has the features mentioned in claim 12.

Advantageous embodiments of the invention are set out in the dependent claims and are explained in greater detail below with the general notion of the invention.

Accordingly, in accordance with the prior art set out in the introduction, in the method according to the invention for cleaning a surface of a steel product, from a nozzle which is located in a position which is associated with an edge of the surface to be cleaned, a fluid jet is directed onto the surface to be cleaned. At the same time, during the cleaning operation, a relative movement is brought about between the nozzle and the steel product. The fluid jet is in this instance orientated transversely relative to the direction of the relative movement of the steel product and nozzle.

According to the invention, from another nozzle which is located in a position which is associated with the edge of the surface to be cleaned, which edge is opposite the edge of the steel product associated with the first nozzle, another fluid jet which is orientated transversely relative to the direction of the relative movement between the nozzles and the steel product with respect to the first fluid jet is directed onto the surface to be cleaned without any overlap.

At the same time according to the invention, the respective striking region in which the fluid jets strike the surface to be cleaned is spaced apart from the edge which is associated with the nozzle which produces the fluid jet, respectively.

A device according to the invention for carrying out the method according to the invention accordingly has a nozzle which is associated with an edge of the surface of the steel product to be cleaned for producing a first fluid jet, there being provided according to the invention a second nozzle for producing a second fluid jet which is directed onto the surface, the second nozzle being associated with the edge of the surface to be cleaned, which is opposite the edge which is associated with the nozzle which produces the other fluid jet, and the nozzles being orientated in such a manner that the fluid jets thereby produced strike in a respective striking region without any overlap the surface to be cleaned of the steel product which is spaced apart from the edge with which the nozzle which produces the respective fluid jet is associated.

According to the invention, the cleaning of the respective surface of the steel product is carried out by means of fluid jets which are produced so as to be directed from opposing edges of the steel product and which are directed counter to each other in terms of their flow direction. The fluid jets are orientated in such a manner that the striking regions thereof when viewed in the direction of the relative movement overlap in a central region of the surface to be cleaned.

When the term “transversely relative to the direction of the relative movement” is used here to describe the orientation of the fluid jets, then this is intended to be understood to refer to any orientation which has a component which is directed transversely relative to the direction of the relative movement, that is to say, in principle any orientation which deviates from a line parallel with the direction of the relative movement. When the surface to be cleaned is viewed from above, the fluid jets may consequently overlap with the direction of the relative movement or a straight line which is orientated in the direction of the relative movement at an angle of, for example, 30°-90°, optimum cleaning results being anticipated with an orthogonal orientation of the fluid jets with respect to the direction of the relative movement or a correspondingly orientated straight line.

The non-overlapping orientation of the fluid jets which are produced so as to extend counter to each other according to the invention prevents the fluid jets from striking each other and prevents the loss, owing to a collision, of kinetic energy which is then no longer available for removing the contamination, oxides and deposits present on the surface to be cleaned.

At the same time, the fluid jets are orientated according to the invention in such a manner that they in each case strike the surface to be cleaned with a given spacing from the edge which is associated with the nozzle which has produced them. The striking region of the fluid jets is accordingly arranged offset in the direction of the opposing edge of the surface to be cleaned in each case. As a result, the edge region of the surface to be cleaned which adjoins the surface edge associated with the respective nozzle is not directly hit by the fluid jet being discharged from the nozzle which is associated with this edge but instead only covered by the fluid jet which is produced by the nozzle associated with the opposite edge of the surface. Since the latter fluid jet has already travelled a longer path on its way to the relevant edge region, it strikes the critical edge region with only a lower level of kinetic energy. The striking region of the fluid jet may alternatively also be focused on the surface to be cleaned in such a manner that the fluid of the fluid jet only washes over the critical region in a shooting flow, without a direct pulse being directed onto the critical edge region by the fluid jet. Consequently, a less abrupt cooling of the edge region is thus achieved so that the risk which otherwise exists of tension cracks occurring as a result of excessive cooling is minimised.

Another advantage of the provision according to the invention to allow the fluid jets to strike the surface to be cleaned with a degree of spacing from the edge thereof and to provide at least two fluid jets which flow from opposing sides and in opposing directions is that, in this manner and without relatively significant reconstruction work or relatively significant adjustment complexity, surfaces of different widths can be cleaned with the same device operated in accordance with the invention. The only important aspect is that sufficient spacing is provided between the edge, with which the nozzle which produces the fluid jet is associated, and the striking region of the respective fluid jet so that the critical peripheral edge region is not directly hit by the fluid jet.

The striking regions of the fluid jets which flow in opposing directions but which do not intersect with each other on the surface to be cleaned are orientated according to the invention in such a manner that the surface to be cleaned is covered with fluid on the whole over the entire width thereof. In the most extreme case, the fluid jets could be orientated for this purpose in such a manner that the striking region thereof, when viewed in the respective flow direction thereof, begins in each case at the centre line of the surface to be cleaned. In this instance, one fluid jet would cover one half of the surface to be cleaned and the other fluid jet would cover the other half of the surface to be cleaned. However, since such a precise orientation in practice cannot be generally implemented with the required reliability, and in order to ensure a good cleaning action, particularly in the central region of the surface to be cleaned, it is advantageous, when viewed in the flow direction of the respective fluid jet, for the striking region of the fluid jets to begin between the centre line of the steel product and the edge of the steel product, which edge is associated with the nozzle which produces the respective fluid jet.

In practice, for this purpose, the spacing KR between the beginning of the striking region of the respective fluid jet and the edge, with which the nozzle producing the respective fluid jet is associated, can be estimated in accordance with the width B of the steel product and the width KA over which the fluid jets which are produced by the nozzles associated with the opposing edges of the steel product overlap when viewed in the direction of the relative movement, according to the formula. KR≧0.5×(B−KA). In this instance, owing to the fact that the condition KA≦B−60 mm is complied with, and the spacing KR is thus in each case at least 30 mm, sufficient spacing with respect to the edge is ensured.

Since a spacing KR of at least 30 mm is complied with, it is ensured under the prevailing conditions in practice that the peripheral edge regions of the steel product to be cleaned, which regions are critical with respect to rapid cooling, are not hit directly by the fluid jet and optimum ductility which prevents the formation of cracks is maintained at that location. With regard to the respective width of the surface to be cleaned and the installation technology available, spacings between the beginning of the striking region of the respective fluid jet and the edge with which the nozzle which produces the respective fluid jet is associated in the order of from 30 to 500 mm, in particular from 30 to 200 mm, have been found to be advantageous in practice.

In order to ensure an optimum cleaning action in the central region of the surface to be cleaned, it is advantageous, when viewed in the direction of the relative movement, for the striking regions of the fluid jets to overlap over a width which corresponds to at least 20% of the spacing which is provided between the edges of the steel product which are associated with the nozzles which produce the fluid jets. In the case of cleaning the surfaces of thin slabs in which the width of the surface to be cleaned is currently typically in the range from 900 to 2100 mm, in particular from 900 to 1600 mm, it has been found to be advantageous in practical tests for the striking regions of the fluid jets to be selected in each case in such a manner that, when viewed in the direction of the relative movement, an overlapping region which is at least 500 mm wide is produced.

The liquid jets are directed according to the invention onto the surface to be cleaned in such a manner that they apply over the striking region thereof a pulse which is sufficient to remove the contamination present on the surface to be cleaned. To this end, the fluid jets can be produced so as to be spread over a specific spraying angle range using correspondingly constructed, commercially available spray nozzles. In practice, spraying angles of between 10° and 45°, preferably between 15° and 30° have been found to be advantageous in this instance. According to experience, with a spread which is too small, the striking region which is covered directly by the respective fluid jet is too small to remove scale particles which adhere to the surface in an operationally reliable manner.

The procedure according to the invention and a device according to the invention can be used in a particularly advantageous manner for cleaning flat surfaces, as provided, for example, in parallelepipedal steel products, in particular slabs or thin slabs, in which the surface to be cleaned extends in a planar manner over the width and length of the steel product. The invention is thus particularly suitable in a casting and rolling installation for cleaning the thin slab surfaces which come into contact with the operating rollers of the roller stands of the hot-rolling segment during the hot-rolling operation, the cleaning according to the invention of these surfaces being carried out before the respective thin slab is introduced into the first hot-rolling stand. Another example of steel products for which the invention is particularly suitable involves flat steel products, such as hot-rolled steel strips or sheets. In this instance, the invention can be used, for example, following a conventional descaler or scale washer in order to remove scale, which may still be present on the steel strip after the scale has been broken, from the surface of the flat steel product in a protective manner.

In principle, it is conceivable for the nozzles which are associated with the edges of the surface to be cleaned and via which the fluid jets are produced to be arranged above the surface to be cleaned in such a manner that, when the surface to be cleaned is viewed from above, they are located inside the surface to be cleaned so as to be offset in the direction of the edge which is associated therewith. According to a robust and functionally stable embodiment of the invention, however, the nozzles are arranged in such a manner that they are arranged during the cleaning operation with a degree of spacing laterally beside the edge of the steel product to be cleaned, which edge is associated therewith in each case. The relevant spacing is advantageously sized in such a manner that the width range which is provided for the steel products which are to be cleaned according to the invention can pass through the device according to the invention, without adaptation of the spacing of the nozzles having to be carried out.

The relative movement between the steel product to be cleaned and the nozzles which produce the fluid jets in a manner according to the invention can be carried out in that the nozzles are moved along the edges of the surface to be cleaned, which edges are associated therewith. However, in production sequences in which the steel product is conveyed in a continuous operation on a conveying path from one processing station to the next, it is advantageous for the nozzles to be arranged in a fixed manner and for the movement of the steel product which is provided for in any case to be used for the relative movement. Such conditions are, for example, present when cleaning thin slabs during the approach to the hot-rolling segment of a casting and rolling installation.

An optimally uniform cleaning action can be achieved in that the fluid jets which are produced in a manner according to the invention are orientated parallel with each other. The overlap-free orientation of the fluid jets transversely relative to the direction of the relative movement can in this instance be implemented in a simple manner in that, when viewed in the direction of the relative movement between the nozzles and the steel product, the nozzle which is associated with one edge is positioned offset with respect to the nozzle associated with the other edge. In this manner, the spacing both of the two fluid jets and of the respective striking regions thereof can be increased as desired, whereby a mutual influence of the two fluid jets can be prevented, even after they have struck the surface of the flat steel product.

Alternatively, it is also possible to arrange the nozzles directly opposite one another and to orientate the fluid jets which they produce in such a manner that they intersect the centre line of the surface to be cleaned at an acute angle. In this instance, it is also possible to carry out a parallel orientation of the fluid jets in order to achieve an intensive uniform cleaning action.

The impact angle of the fluid jets can also be influenced by the height at which the nozzles are arranged with respect to the surface of the flat steel product to be cleaned. The further the nozzles are from this surface, the steeper the impact angle of the fluid jets is. In the event of an excessively steep impact angle of the fluid jets, however, there is the risk that they will be too powerfully reflected. Therefore, according to another practical embodiment of the invention, the respective perpendicular spacing of the nozzles with respect to the surface of the flat steel product to be cleaned is a maximum of 45%, in particular a maximum of 12.5%, of the maximum width of the flat steel product. With a width of the flat steel product of from 900 to 1600 mm, which width is typical in practice, this corresponds to a perpendicular spacing of a maximum of 700 mm, preferably a perpendicular spacing of a maximum of 200 mm. In order to ensure that the nozzles under the conditions present in practice do not collide with the steel product to be cleaned in each case, the minimum spacing between the nozzles and the surface to be cleaned should be at least 20 mm in height, in particular at least 40 mm.

The impact angle of the fluid jets on the surface to be cleaned is further significantly determined by the angle of inclination which is enclosed as an obtuse angle between a vertical line and the centre axis of the fluid jets, at which angle the centre axis of the fluid jets produced by the nozzles is orientated. In order to prevent the fluid jets partially or completely shooting past the surface of the flat steel product, the nozzles are not intended to be directed away from the surface to be cleaned. At the same time, the angle of inclination should also not be too large so as to prevent the fluid jets from striking the surface to be cleaned at an excessively steep impact angle. Accordingly, according to an advantageous embodiment of the invention, the angle of inclination is in the range of >90° to 135°, in particular >90° to 105°, so that the centre axis of the fluid jets with horizontal orientation of the surface of the steel product to be cleaned strikes the surface to be cleaned at an angle of >0° to 45°, in particular >0° to 15°.

Of course, two or more nozzles may also be associated with the edges of the surface of the steel product to be cleaned if this is, for example, advantageous for increasing the productivity or for homogenisation of the cleaning result.

The method according to the invention and the device according to the invention are particularly suitable for use in casting and rolling installations, strip casting installations or hot-rolling works for cleaning slabs, thin slabs, cast strip or hot-rolled steel strips (“hot strips”).

The invention is explained in greater detail below with reference to embodiments. In the schematic drawings:

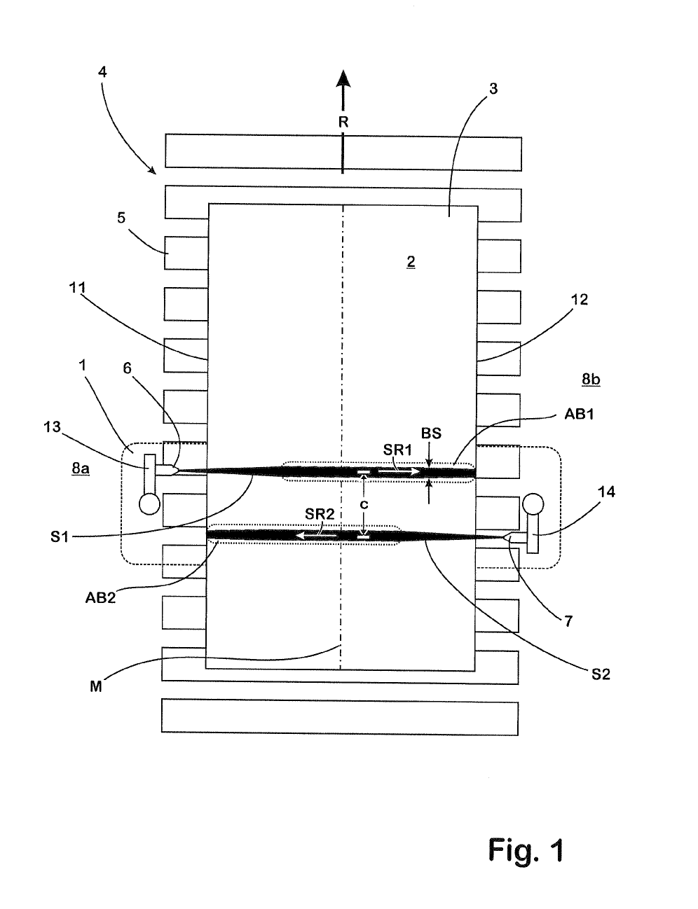

FIG. 1 is a top view of a device arranged on a roller table of a casting and rolling installation for cleaning the surface of thin slabs, in the direction towards the surface of the thin slab to be cleaned;

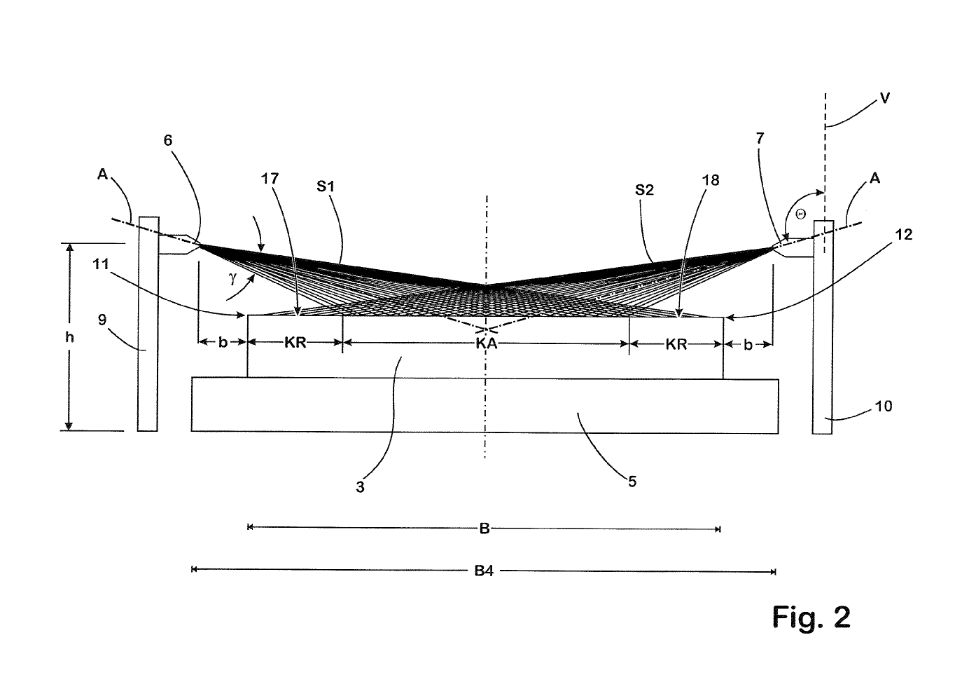

FIG. 2 is a front view of the device according to FIG. 1;

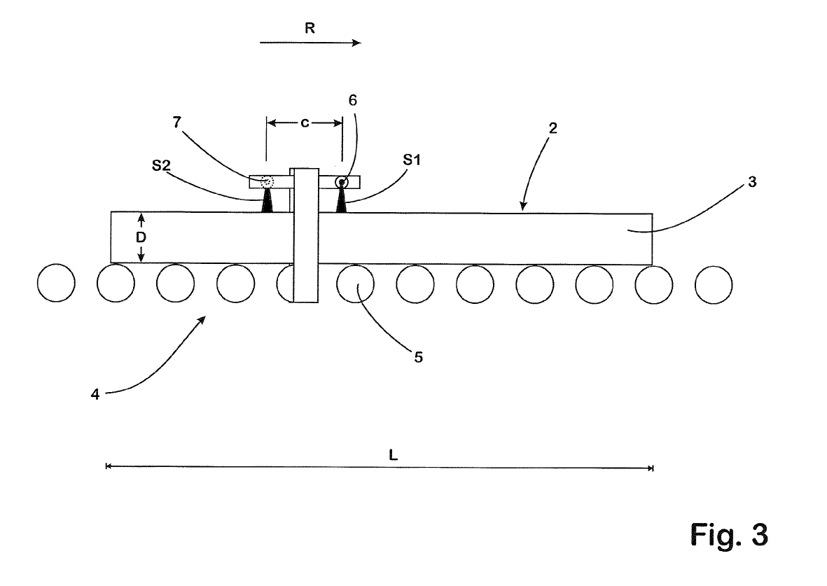

FIG. 3 is a side view of the device according to FIGS. 1 and 2.

The device 1 for cleaning a surface 2 of a parallelepipedal thin slab 3 is arranged on a roller table 4 on which the thin slab 3 is transported, for example, to the first roller stand of a hot-rolling segment which is not illustrated in this instance and which is part of a casting and rolling installation which is also not shown in greater detail here.

The thin slab 3 has, for example, a thickness D of 60 mm, a width B of 1500 mm and a length L of 40 m. The surface 2 which is to be cleaned and which is constructed to be planar to the greatest possible extents located in this instance at the exposed upper side of the thin slab 3, which is moved with the lower side thereof opposite the surface 2 to be cleaned on the rollers 5 of the roller table 2 in the conveying direction R. The thin slab 3 is thus conveyed in a linear relative movement along the fixedly arranged device 1. The thin slab 3 is orientated substantially centrally with respect to the width B4 of the roller table 4 so that the centre line M of the surface 2 to be cleaned extending in the conveying direction R of the relative movement under optimal operating conditions when viewed from above (FIG. 1) coincides with the centre line of the roller table 4.

On the surface 2 of the thin slab 3 to be cleaned there are scale particles and other contamination which arises from the preceding operating steps of the thin slab production.

The device 1 for cleaning the surface 2 comprises two nozzles 6, 7, one nozzle 6 of which is arranged at the so-called operator side 8a of the roller table 4, from which side service operations are generally carried out on the roller table 4, and the other nozzle 7 is arranged at the so-called drive side 8b of the roller table 4, at which side the drives of the rollers 5 of the roller table 4 are located, which drives are not illustrated here for reasons of clarity.

The nozzles 6, 7 may, for example, be conventional flat jet nozzles and flat jet tongue nozzles.

The fluid jets S1, S2 comprise water which is conveyed to the nozzles 6, 7 in a state acted on with sufficiently high pressure via a supply device which is not illustrated here.

The nozzles 6, 7 are each secured to a frame 9, 10 by means of which the height h thereof above the surface 2 to be cleaned, the spacing b with respect to the edge 11, 12 of the thin slab 3 associated with it and the angle of inclination B measured between the vertical V and the centre axis A of the fluid jets S1, S2 produced by the nozzles 6, 7 can be adjusted. To this end, the nozzles 6, 7 are mounted in each case on a horizontally orientated carrier arm 13, 14 of the frames 9, 10 in such a manner that, when viewed in the conveying direction R, they are arranged offset relative to each other with a spacing c. The maximum spacing of the nozzles 6, 7 is sized in such a manner that the entire width range, in which the thin slabs can be produced in the casting and rolling installation, can pass through the device 1 without basic reconstruction work.

The nozzles 6, 7 produce the fluid jets S1, S2 in the manner of a cutting blade jet so that, when viewed from above, the centre axis A thereof intersects with the centre line M of the surface 2 to be cleaned at a right angle and, on the one hand, the width BS of the fluid jets S1, S2 measured in the conveying direction R is tightly limited and, on the other hand, the fluid jets S1, S2 are spread out at a spraying angle γ after leaving the nozzles 6, 7. The orientation of the nozzles 6, 7 or the fluid jets S1, S2 produced by them is at the same time selected in such a manner that the fluid jets S1, S2 strike the surface 2 of the thin slab 3 to be cleaned parallel with each other and with mutually oppositely orientated flow directions SR1, SR2, without impeding each other as a result of overlapping. The striking regions 15, 16 in which the fluid jets S1, S2 strike the surface 2 to be cleaned are arranged in this instance with a spacing KR with respect to the edge 11, 12 associated with the nozzle 6, 7 which produces the respective fluid jet S1, S2 so that the fluid jets S1, S2 when viewed in the conveying direction R (FIG. 2) overlap over a width KA which is ideally orientated symmetrically with respect to the centre line M.

In the edge region 17, 18 which adjoins the respective edge 11, 12 and which extends over the spacing KR and the length L of the thin slab KR, the fluid jet S1, S2 which is produced from the nozzle 6, 7 which is associated with the respective edge 11, 12 accordingly does not strike directly. Instead, the respective edge regions 15, 16 are washed only by the fluid jet S2, S1 which is produced by the nozzle 7, 6 arranged at the opposing side, respectively.

The spacing KR is in practice from 30 to 200 mm, preferably from 100 to 150 mm, in order to ensure that the peripheries at the lateral edges 11, 12 of the surface 2 cannot be struck. In this manner, a ductility of the thin slab 2 in the edge regions 15, 16 is ensured, which ductility is sufficient to prevent edge defects in the following hot-rolling operation.

The width KA of the overlap of the fluid jets S1, S2 is intended in practice to be at least 250 mm in order to ensure sufficiently intensive cleaning of the centre region of the surface 2 to be cleaned.

The spraying angle γ is intended to be in the range from 10 to 45°, in particular from 10 to 30°. With an excessively low spraying angle γ, the fluid jets S1, S2 when striking the surface 2 to be cleaned cover an excessively small striking region AB1, AB2 so that insufficient cleaning or removal of loose scale particles is carried out. However, when an angle of 45° is greatly exceeded, the spray spread is excessively powerfully splayed and the pulse which can be achieved by the impact and flow of the fluid jet is too small for sufficient cleaning.

The greater the height h of the nozzles above the surface 2 to be cleaned is selected to be, the greater the inclination angle Θ should be selected to be in order with the lower side of the water fan formed from the respective fluid jet S1, S2 to reach the predetermined striking region AB1, AB2 on the surface 2 to be cleaned. At such a height above 700 mm, this angle would be so steep in the case of the currently conventional thin slabs 3 that the respective fluid jet S1, S3 would be powerfully reflected upwards when striking the surface 2, and there would no longer be sufficient cleaning. Falling greatly below the value of 20 mm is not advantageous since there is then the risk that the nozzles 6, 7 will become damaged as a result of a collision with a thin slab 3 which is not transported centrally over the roller table 4.

The angle of inclination Θ is selected in accordance with the height h in such a manner that the water fan formed from the respective fluid jet S1, S2 safely reaches the predetermined striking region AB1, AB2. Angles of inclination Θ greatly below 90° are not generally advantageous since the majority of spraying water then shoots past the thin slab without being used. Angles significantly larger than 135° are also not advantageous since they are then so steep that the water jet could be powerfully reflected upwards when striking the upper side of the slab and adequate cleaning would no longer be provided for.

The spacing c of the two fluid jets S1, S2 from each other in the direction R of the relative movement is selected in such a manner that the fluid jets do not impede each other.

With the device 1 schematically illustrated in the Figures, ten tests E1-E10 have been carried out. The parameters which are adjusted in this instance of: the width B of the thin slab 3 cleaned, spraying angle γ of the nozzles 6, 7, inclination angle Θ, spacing KR, width KA of the overlap region, height h of the nozzles 6, 7 above the surface 2 to be cleaned, lateral spacing b of the nozzles 6, 7 with respect to the thin slab 3 and spacing c of the fluid jets S1, S2 in the conveying direction R and the nozzle type used, an evaluation of the “scale defects” which can be determined in respect of the completed strip in the form of rolled-in scale and an evaluation of the edge defects which have occurred during the subsequent hot-rolling operation, are set out in Table 1.

It has been found that with the procedure according to the invention (tests E1-E10) at most a small number of slight defects (evaluation “+”) or no defects at all (evaluation “++”) were found on the hot strip which was produced from a thin slab 3 in a manner according to the invention.

For comparison, two additional tests V1, V2 were carried out with a device which is not shown here and whose basic structure corresponded to the device 1, but in which two nozzles had been positioned at the same side 11 and were directed without compliance with a spacing KR towards the edge of the slab to be cleaned in each case. However, this arrangement resulted in substantial defects (evaluation “−”) or many serious defects (evaluation “−−”).

### REFERENCE NUMERALS

1 Device for cleaning the surface of the thin slab 3
2 Surface of the thin slab 3 to be cleaned
3 Thin slab
4 Roller table
5 Rollers of the roller table 2
6, 7 Nozzles for producing the fluid jets S1, S2
8a Operator side of roller table 4
8b Drive side of roller table 4
9, 10 Frames
11, 12 Edge of surface 2 of the thin slab 3 to be cleaned
13, 14 Carrier arm of the frames 9, 10
15, 16 Striking regions of fluid jets S1, S2 on surface 2 to be cleaned
17, 18 Edge regions of surface 2 to be cleaned
γ Spraying angle
Θ Inclination angle
b Spacing of nozzles 6, 7 from edge 11, 12 of thin slab 3, which edge is associated therewith
c Spacing
h Height of nozzles 6, 7
A Centre axis of the fluid jets S1, S2
AB1, AB2 Striking region of the fluid jets S1, S2
B Width of the thin slab 3
B4 Width of the roller table 4
BS Width of the fluid jets S1, S2
D Thickness of the thin slab 3
KA Width over which the fluid jets overlap when viewed in conveying direction R
KR Spacing from the edge 11, 12 associated with the nozzle 6, 7 producing the fluid jet S1, S2
L Length of the thin slab 3
M Centre line of the surface 2 to be cleaned
R Conveying direction in which the thin slab 3 is moved relative to the nozzles 6, 7 arranged so as to be fixed in position
S1, S2 Fluid jets
SR1, SR2 Flow direction of the fluid jets S1, S2
V Vertical line

TABLE 1

| | B | γ | Θ | KR | KA | h | b | c | Nozzle | Scale | Edge |
|---|---|---|---|---|---|---|---|---|---|---|---|
| No. | [mm] | [°] | [°] | [mm] | [mm] | [mm] | [mm] | [mm] | type | defect | cracks |
| E1 | 1520 | 15 | 97 | 410 | 700 | 150 | 190 | 150 | Flat | + | + |
| | | | | | | | | | jet | | |
| E2 | 1280 | 15 | 97 | 290 | 700 | 150 | 310 | 150 | Flat | + | ++ |
| | | | | | | | | | jet | | |
| E3 | 961 | 15 | 97 | 130 | 700 | 150 | 470 | 150 | Flat | ++ | ++ |
| | | | | | | | | | jet | | |
| E4 | 1075 | 15 | 97 | 188 | 700 | 150 | 413 | 150 | Flat | ++ | ++ |
| | | | | | | | | | jet | | |
| E5 | 1387 | 15 | 97 | 344 | 700 | 150 | 257 | 150 | Flat | ++ | ++ |
| | | | | | | | | | jet | | |
| E6 | 1416 | 15 | 97 | 358 | 700 | 150 | 242 | 150 | Flat | ++ | ++ |
| | | | | | | | | | jet | | |
| E7 | 1459 | 15 | 97 | 380 | 700 | 150 | 221 | 150 | Flat | ++ | ++ |
| | | | | | | | | | jet | | |
| E8 | 1555 | 15 | 97 | 428 | 700 | 150 | 173 | 150 | Flat | ++ | ++ |
| | | | | | | | | | jet | | |
| E9 | 1561 | 15 | 97 | 431 | 700 | 150 | 170 | 150 | Flat | ++ | ++ |
| | | | | | | | | | jet | | |
| E10 | 1593 | 15 | 97 | 447 | 700 | 150 | 154 | 150 | Flat | ++ | ++ |
| | | | | | | | | | jet | | |
| V1 | 1280 | 30 | 110 | 0 | 1280 | 150 | 310 | 100 | Flat | −− | − |
| | | | | | | | | | jet | | |
| V2 | 1270 | 30 | 110 | 0 | 1270 | 150 | 315 | 100 | Flat | − | −− |
| | | | | | | | | | jet | | |

1. A method for cleaning a surface of a steel product, comprising, directing a fluid jet from a nozzle which is located in a position which is associated with an edge of the surface to be cleaned, onto the surface to be cleaned, wherein, during cleaning, there is produced a relative movement between the nozzle and the steel product and wherein the fluid jet is orientated transversely relative to the direction of the relative movement of the steel product and nozzle wherein,
from another nozzle which is located in a position which is associated with the edge of the surface to be cleaned, which edge is opposite the edge of the steel product associated with the first nozzle, another fluid jet, which is orientated transversely relative to the direction of the relative movement between the nozzles and the steel product, with respect to the first fluid jet is directed onto the surface to be cleaned without any overlap, wherein a
striking region in which the fluid jets strike the surface to be cleaned is spaced apart from the edge which is associated with the nozzle which produces the fluid jet, respectively.

2. The method according to claim 1, wherein the striking region of the fluid jets begins between the centre line of the surface of the steel product to be cleaned and the edge of the steel product, which edge is associated with the nozzle which produces the respective fluid jet.

3. The method according to claim 2, wherein a spacing, KR, between the beginning of the striking region of the respective fluid jet and the edge with which the nozzle producing the respective fluid jet is associated, is adjusted, in accordance with the width, B, of the steel product and with the width, KA, over which the fluid jets which are produced by the nozzles associated with the opposing edges of the steel product overlap when viewed in the direction of the relative movement, according to the following formula:
KR≧0.5×(B−KA).

4. The method according to claim 3, wherein the spacing between the striking region of the fluid jets and the edge which is associated with the nozzle which produces the respective fluid jet is at least 30 mm.

5. The method according to claim 1, wherein the striking regions of the fluid jets overlap over a width which corresponds to at least 20% of the spacing which is provided between the edges of the steel product which are associated with the nozzles which produce the fluid jets.

6. The method according to claim 1, wherein the spraying angle over which the fluid jet spreads after the discharge from the nozzle is from 10° to 45°.

7. The method according to claim 1, wherein the inclination angle enclosed as an obtuse angle between a vertical line and the centre axis of the fluid jets is from 90° to 135°.

8. The method according to claim 1, wherein the steel product is parallelepipedal and the surface to be cleaned extends in a planar manner over the width and length of the steel product.

9. The method according to claim 1, wherein the nozzles which produce the fluid jets are each arranged at the side of the steel product and with spacing from the edge of the steel product associated therewith.

10. The method according to claim 1, wherein the nozzle which is associated with one edge is positioned offset with respect to the nozzle associated with the other edge.

11. The method according to claim 1, wherein the nozzles are arranged so as to be fixed in position and the steel product is moved on a conveying path relative to the nozzles.

12. The method according to claim 1, wherein at least the fluid jet which is produced by one nozzle is orientated orthogonally relative to the direction of the relative movement between the steel product and the nozzles.

13. The method according to claim 1, wherein the method is used in strip casting installations, casting and rolling installations or hot-rolling works for cleaning slabs, thin slabs, cast strip or hot-rolled steel strips.

14. A device for cleaning a surface of a steel product, comprising a nozzle which is associated with an edge of the surface of the steel product to be cleaned for producing a first fluid jet wherein a second nozzle is provided for producing a second fluid jet which is directed onto the surface wherein the second nozzle is associated with an edge of the surface to be cleaned, which is opposite the edge with which the nozzle which produces the other fluid jet is associated, and in that the nozzles orientated in such a manner that the fluid jets produced strike in a respective striking region without any overlap on the surface to be cleaned of the steel product which is spaced apart from the edge with which the nozzle which produces the respective fluid jet is associated.

15. The device according to claim 14, wherein the device is used for cleaning slabs, thin slabs, cast strips or hot strips in strip casting installations, casting and rolling installations or hot strip works.
